(19) United States
(12) Patent Application Publication
(10) Pub. No.: US 2011/0041175 A1
(43) Pub. Date: Feb. 17, 2011

(54) SYSTEM AND METHOD FOR INTEGRATING OPERATION OF SYSTEMS EMPLOYING SINGLE SIGN-ON AUTHENTICATION

(76) Inventor: Andrey I. SAVOV, Fullerton, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/539,846

(22) Filed: Aug. 12, 2009

(51) Int. Cl. G06F 15/16

(52) U.S. Cl. 726/8

(57) ABSTRACT

The subject application is directed to a system and method for integrating operation of systems employing distinct authentication. Department code data is first received from an associated user via a user interface of a document processing device. The received department code data is then communicated from the document processing device to an authentication translation server. A data map of department code data relative to enterprise authentication data is then stored in a memory associated with the authentication translation server. Application authentication data is then received into an enterprise application server corresponding to the received department code. Application authentication data is then retrieved corresponding to the received department code from the memory. The authenticity of the retrieved authentication data is then tested. The enterprise application server is then selectively operated in accordance with the testing.

### BACKGROUND OF THE INVENTION

The subject application is directed generally to cooperation between systems employing distinct authentication systems. The system is particularly applicable to document processing devices that use department code login data which access enterprise application services that require credentials, such as username and password.

Devices commonly used in offices or enterprises rely on user login information to facilitate allocation of costs for resource usage or restrict usage of resources. Many devices, such as copiers, printers, facsimile machines, scanners or multifunction peripherals may require device users to login with a department code to use a device. In some instances, the department code may take the form of a personal identification code or PIN.

Office devices are often integrated, via data networks, with servers, such as enterprise servers, that have their own security or authentication systems, such as username and password. It may be desirable to access such systems via a document processing device. However, the disparate authentication systems are typically incompatible.

### SUMMARY OF THE INVENTION

In accordance with one embodiment of the subject application, there is provided a system and method for integrating operation of systems employing distinct authentication. Department code data is first received from an associated user via a user interface of a document processing device. The received department code data is then communicated from the document processing device to an authentication translation server. A data map of department code data is then stored in a memory associated with the authentication translation server relative to enterprise authentication data. Application authentication data corresponding to the received department code is then received into an enterprise application server. From the memory, application authentication data is retrieved corresponding to the received department code. The authenticity of the retrieved authentication data is then tested. The enterprise application server is then selectively operated based upon the results of the testing.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for integrating operation of systems employing distinct authentication according to one embodiment of the subject application;

FIG. 2 is a block diagram illustrating device hardware for use in the system for integrating operation of systems employing distinct authentication according to one embodiment of the subject application;

FIG. 3 is a functional diagram illustrating the device for use in the system for integrating operation of systems employing distinct authentication according to one embodiment of the subject application;

FIG. 4 is a block diagram illustrating controller hardware for use in the system for integrating operation of systems employing distinct authentication according to one embodiment of the subject application;

FIG. 5 is a functional diagram illustrating the controller for use in the system for integrating operation of systems employing distinct authentication according to one embodiment of the subject application;

FIG. 6 is a functional diagram illustrating a workstation for use in the system for integrating operation of systems employing distinct authentication according to one embodiment of the subject application;

FIG. 7 is a functional diagram illustrating a server for use in the system for integrating operation of systems employing distinct authentication according to one embodiment of the subject application;

FIG. 8 is a block diagram illustrating the system for integrating operation of systems employing distinct authentication according to one embodiment of the subject application;

FIG. 9 is a functional diagram illustrating the system for integrating operation of systems employing distinct authentication according to one embodiment of the subject application;

FIG. 10 is a flowchart illustrating a method for integrating operation of systems employing distinct authentication according to one embodiment of the subject application; and

FIG. 11 is a flowchart illustrating a method for integrating operation of systems employing distinct authentication according to one embodiment of the subject application.

### DETAILED DESCRIPTION OF THE PREFERRED EMBODIMENT

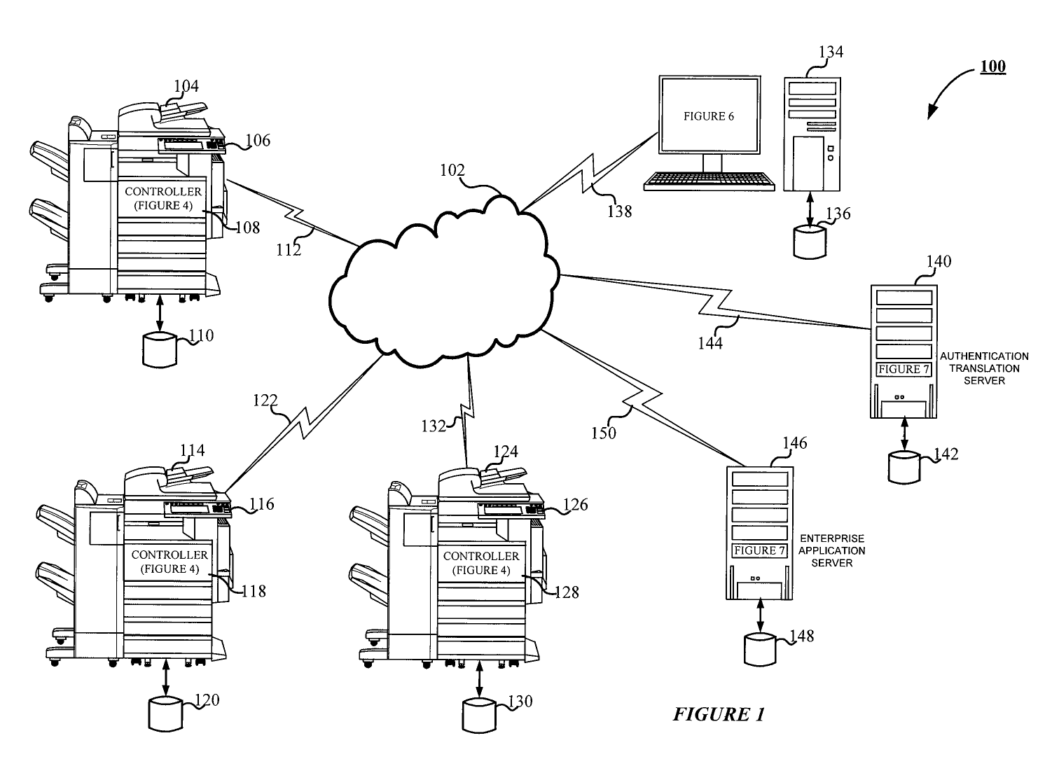

The subject application is directed to a system and method for cooperation between systems employing distinct authentication systems. In particular, the subject application is directed to a system and method for document processing devices that use department code login data which access enterprise application services that require credentials, such as username and password. More particularly, the subject application is directed to a system and method that is applicable to integrating operation of systems that employ disparate and distinct authentication. It will become apparent to those skilled in the art that the system and method described herein are suitably adapted to a plurality of varying electronic fields employing automated configuration, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for integrating operation of systems employing distinct authentication in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also one or more document processing devices, depicted in FIG. 1 as the document processing devices 104, 114, and 124. As shown in FIG. 1, the document processing devices 104, 114, and 124 are illustrated as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 114, and 124 are suitably adapted to provide remote document rendering services to external or network devices. According to one embodiment of the subject application, the document processing devices 104, 114, and 124 include hardware, software, and any suitable combination thereof, configured to interact with an associated user, a networked device, or the like. Preferably, the document processing devices 104, 114, and 124 are capable of communicating electronic documents to and from each other in accordance with user provided instructions, transferring electronic documents amongst each other based upon output capabilities, locations, or the like.

According to one embodiment of the subject application, the document processing devices 104, 114, and 124 are suitably equipped to receive a plurality of portable storage media, including, without limitation, Firewire drive, USB drive, SD, MMC, XD, Compact Flash, Memory Stick, and the like. In the preferred embodiment of the subject application, the document processing devices 104, 114, and 124 further include associated user interfaces 106, 116, and 126, such as a touch-screen, LCD display, touch-panel, alpha-numeric keypad, or the like, via which an associated user is able to interact directly with the document processing devices 104, 114, and 124. In accordance with the preferred embodiment of the subject application, the user interfaces 106, 116, and 126 are advantageously used to communicate information to associated users and receive selections from such associated users.

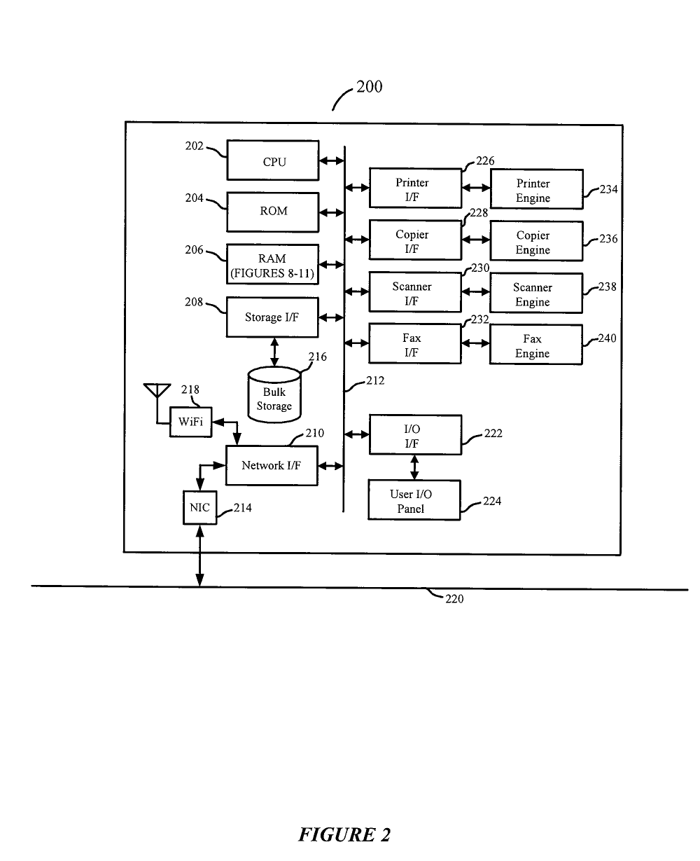

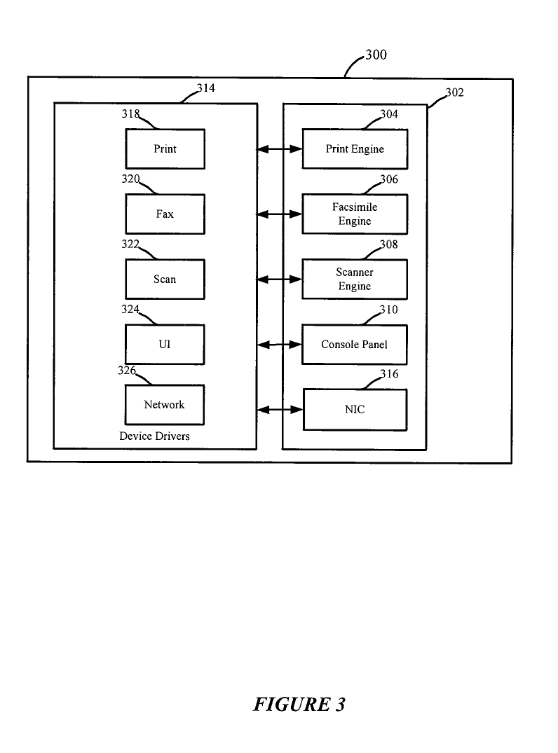

The skilled artisan will appreciate that the user interfaces 106, 116, and 126 comprise various components, suitably adapted to present data to associated users, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as controllers 108, 118, and 128, as explained in greater detail below. Preferably, the document processing devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104, 114, and 124 will be better understood in conjunction with the block diagrams illustrated in FIGS. 2 and 3, explained in greater detail below.

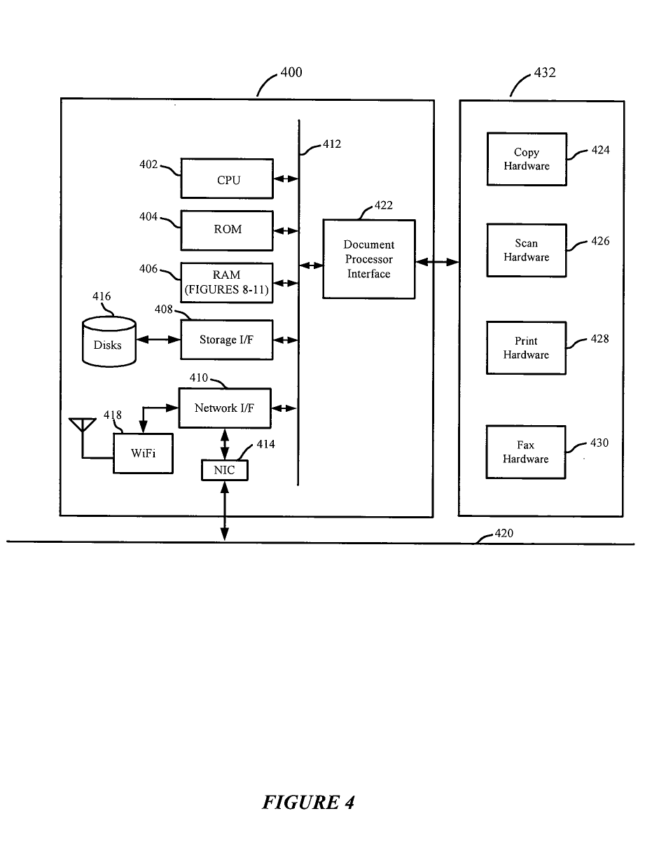

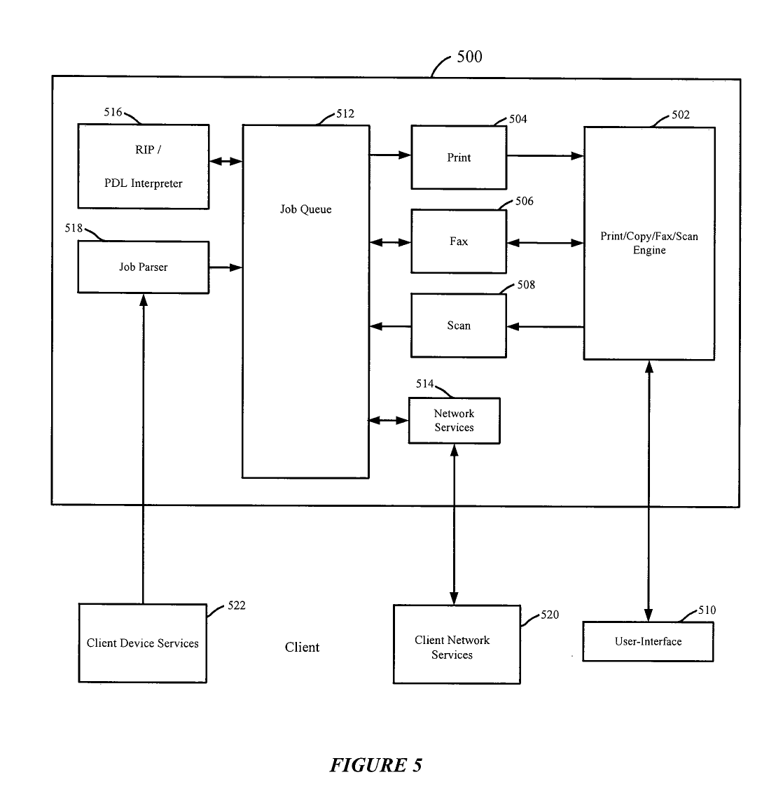

In accordance with one embodiment of the subject application, the document processing devices 104, 114, and 124 further incorporate a backend component, designated as the controllers 108, 118, and 128, suitably adapted to facilitate the operations of their respective document processing devices 104, 114, and 124, as will be understood by those skilled in the art. Preferably, the controllers 108, 118, and 128 are embodied as hardware, software, or any suitable combination thereof, configured to control the operations of the associated document processing devices 104, 114, and 124, facilitate the display of images via the user interfaces 106, 116, and 126, direct the manipulation of electronic image data, maintain the security of applications, user information, data, and the like. For purposes of explanation, the controllers 108, 118, and 128 are used to refer to any myriad of components associated with the document processing devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such a general computing device and is intended as such when used hereinafter. Furthermore, the use of the controllers 108, 118, and 128 hereinafter is for the example embodiment only, and other embodiments, which will be apparent to one skilled in the art, are capable of employing the system and method for integrating operation of systems employing distinct authentication of the subject application. The functioning of the controllers 108, 118, and 128 will better be understood in conjunction with the block diagrams illustrated in FIGS. 4 and 5, explained in greater detail below.

Communicatively coupled to the document processing devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store security levels, security software, document data, image data, electronic database data, or the like. It will be appreciated by those skilled in the art that while illustrated in FIG. 1 as being a separate component of the system 100, the data storage devices 110, 120, and 130 are capable of being implemented as internal storage components of the document processing devices 104, 114, and 124, components of the controllers 108, 118, and 128, or the like, such as, for example and without limitation, an internal hard disk drive, or the like.

Also depicted in FIG. 1 is an administrative device, illustrated as a computer workstation 134, in data communication with the computer network 102 via a communications link 138. It will be appreciated by those skilled in the art that the administrative device 134 is shown in FIG. 1 as a workstation computer for illustration purposes only. As will be understood by those skilled in the art, the administrative device 134 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the administrative device 134 further includes software, hardware, or a suitable combination thereof configured to interact with the document processing devices 104, 114, and 124, or the like. In one embodiment of the subject application, the administrative device 134 includes one or more drivers suitably configured to interact with the document processing devices 104, 114, and 124, prepare electronic documents for output thereby, and the like, as will be understood by those skilled in the art.

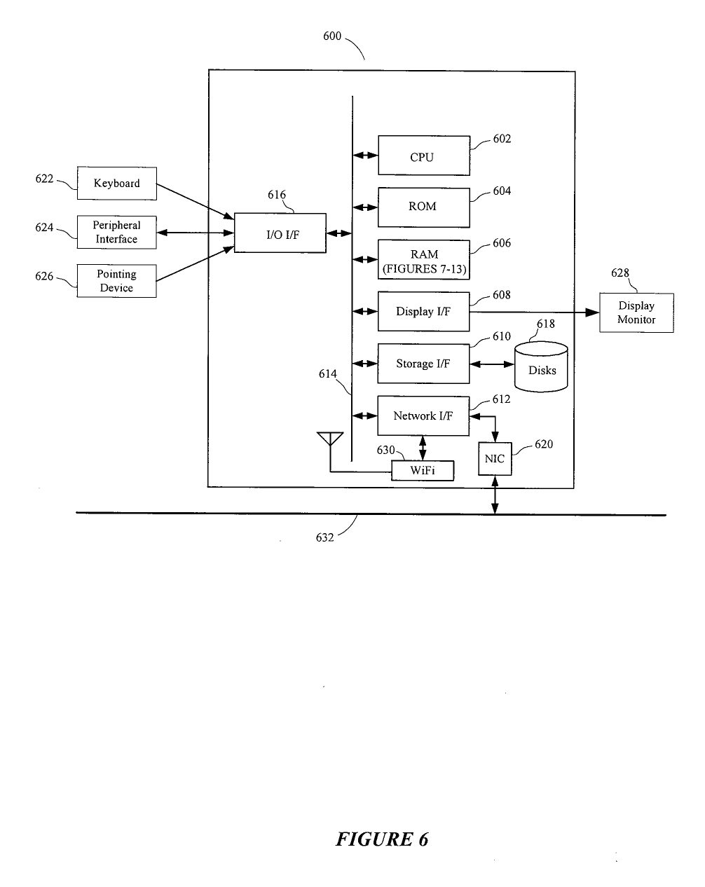

The communications link 138 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrative device 134 is suitably adapted to provide mapping data, user account management data, job data, user interface data, image data, monitor document processing jobs, employ thin-client interfaces, generate display data, generate output data, or the like, with respect to the document processing devices 104, 114, or 124, or any other similar device coupled to the computer network 102. The functioning of the administrative device 134 will better be understood in conjunction with the block diagram illustrated in FIG. 6, discussed in greater detail below.

Communicatively coupled to the administrative device 134 is the data storage device 136. According to the foregoing example embodiment, the data storage device 136 is any mass storage device, or plurality of such devices, known in the art including, for example and without limitation, magnetic storage drives, a hard disk drive, optical storage devices, flash memory devices, or any suitable combination thereof. In such an embodiment, the data storage device 136 is suitably adapted to store user account data, administrative setting data, electronic document data, document processing device identification data, document processing device drivers, and the like. It will be appreciated by those skilled in the art that while illustrated in FIG. 1 as being a separate component of the system 100, the data storage device 136 is capable of being implemented as an internal storage component of the administrative device 134, or the like, such as, for example and without limitation, an internal hard disk drive, or the like.

The system 100 illustrated in FIG. 1 further depicts a first backend component, shown as the authentication translation server 140, in data communication with the computer network 102 via a communications link 142, and a second backend component, shown as the enterprise application server 146, in data communication with the computer network 102 via a communications link 150. It will be appreciated by those skilled in the art that the servers 140 and 146 are shown in FIG. 1 as components of the system 100 for example purposes only, and the subject application is capable of implementation without the use of separate backend server components, e.g. the servers 140 and 146 are capable of implementation via the document processing devices 104, 114, or 124, or via the administrative device 134. The skilled artisan will appreciate that the servers 140 and 146 comprise hardware, software, and combinations thereof suitably adapted to provide one or more services, web-based applications, user authentication verification, storage options, and the like, to networked devices. In accordance with one example embodiment of the subject application, the servers 140 and 146 include various components, implemented as hardware, software, or a combination thereof, for authenticating user information, managing workflow, managing retention of documents, processing text data, performing searches, performing comparisons, maintaining database entries, account information, receiving payment data, retrieval of documents, and the like, which are accessed via the computer network 102.

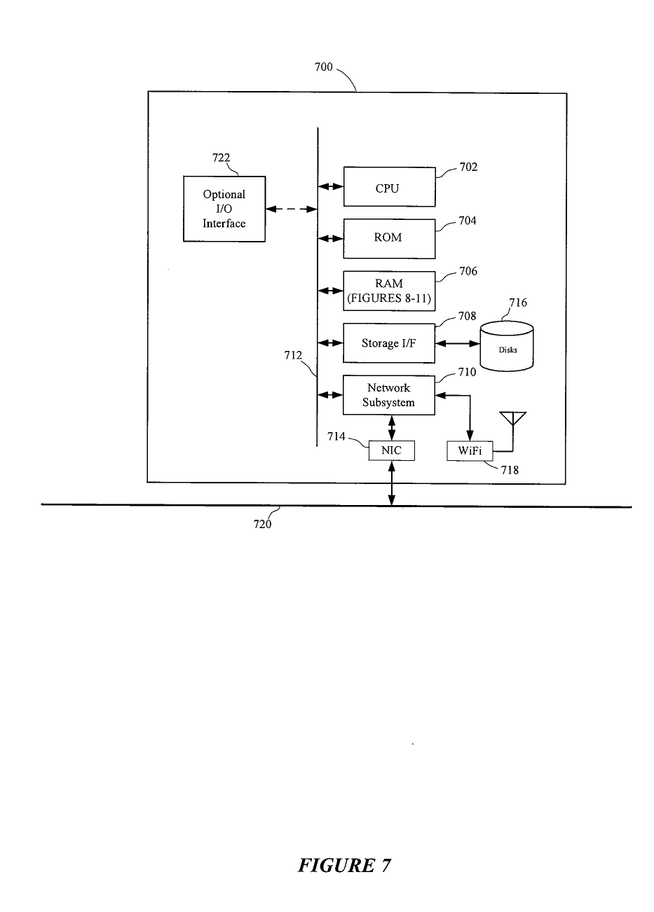

The communications links 144 and 150 are any suitable data communications means known in the art including, but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the servers 140 and 146 are capable of implementation on any suitable computing device coupled to the computer network 102, e.g. the controllers 108, 118, or 128, or the like. The functioning of the servers 140 and 146 will better be understood in conjunction with the block diagram illustrated in FIG. 7, explained in greater detail below.

Communicatively coupled to the servers 140 and 146 are the data storage devices 142 and 148, respectively. According to the foregoing example embodiment, the data storage devices 142 and 148 are any mass storage device, or plurality of such devices, known in the art including, for example and without limitation, magnetic storage drives, a hard disk drive, optical storage devices, flash memory devices, or any suitable combination thereof. In such an embodiment, the data storage devices 142 and 148 are suitably adapted to store user information, database information, document processing device information, application data, a document management system data, electronic documents, tag data, positioning data, layout data, and the like. It will be appreciated by those skilled in the art that while illustrated in FIG. 1 as being separate components of the system 100, the data storage devices 142 and 148 are capable of being implemented as internal storage components of the respective servers 140 and 146, or the like, such as, for example and without limitation, an internal hard disk drive, or the like.

Turning now to FIG. 2, illustrated is a representative architecture of a suitable device 200, shown in FIG. 1 as the document processing devices 104, 114, and 124, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing devices 104, 114, and 124, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controllers 108, 118, and 128) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown as the computer workstation 134, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

Turning now to FIG. 7, illustrated is a representative architecture of a suitable server 700 (depicted in FIG. 1 as the authentication translation server 140 and the enterprise application server 146), on which operations of the subject system are completed. Included is a processor 702, suitably comprised of a central processor unit. However, it will be appreciated that processor 702 may advantageously be composed of multiple processors working in concert with one another as will be appreciated by one of ordinary skill in the art. Also included is a non-volatile or read only memory 704 which is advantageously used for static or fixed data or instructions, such as BIOS functions, system functions, system configuration, and other routines or data used for operation of the server 700.

Also included in the server 700 is random access memory 706, suitably formed of dynamic random access memory, static random access memory, or any other suitable, addressable memory system. Random access memory provides a storage area for data instructions associated with applications and data handling accomplished by the processor 702.

A storage interface 708 suitably provides a mechanism for volatile, bulk or long term storage of data associated with the server 700. The storage interface 708 suitably uses bulk storage, such as any suitable addressable or serial storage, such as a disk, optical, tape drive and the like as shown as 716, as well as any suitable storage medium as will be appreciated by one of ordinary skill in the art.

A network interface subsystem 710 suitably routes input and output from an associated network allowing the server 700 to communicate to other devices. The network interface subsystem 710 suitably interfaces with one or more connections with external devices to the server 700. By way of example, illustrated is at least one network interface card 714 for data communication with fixed or wired networks, such as Ethernet, token ring, and the like, and a wireless interface 718, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 714 is interconnected for data interchange via a physical network 720, suitably comprised of a local area network, wide area network, or a combination thereof.

Data communication between the processor 702, read only memory 704, random access memory 706, storage interface 708 and the network subsystem 710 is suitably accomplished via a bus data transfer mechanism, such as illustrated by bus 712.

Suitable executable instructions on the server 700 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 722 as will be appreciated by one of ordinary skill in the art.

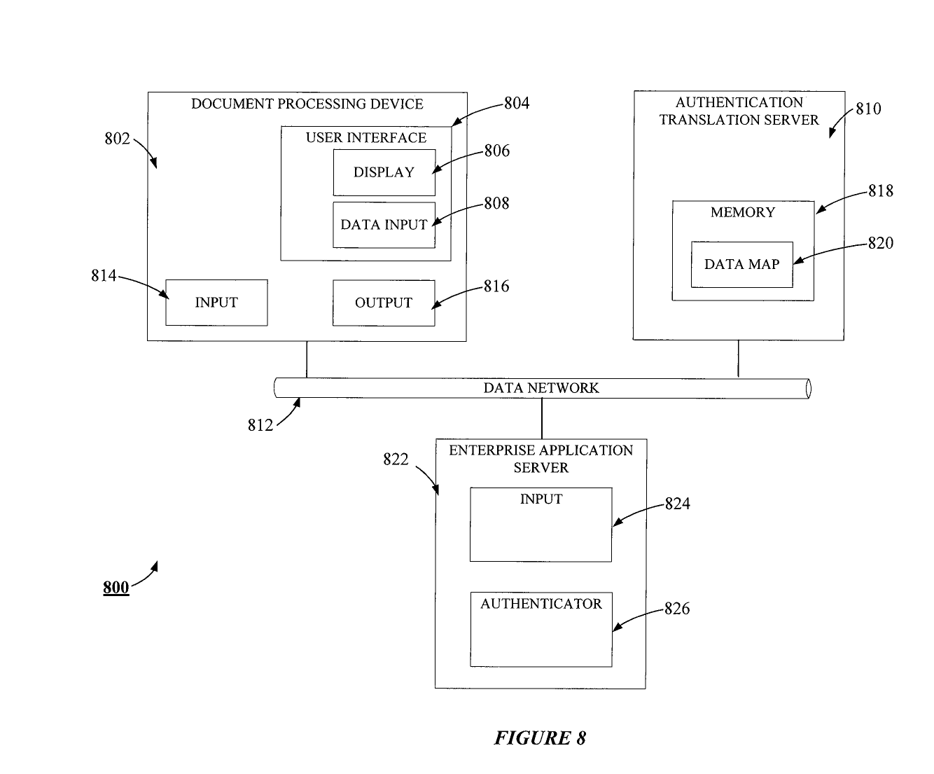

Referring now to FIG. 8, illustrated is a block diagram of a system 800 for integrating operation of systems employing distinct authentication in accordance with one embodiment of the subject application. As shown in FIG. 8, the system 800 includes a document processing device 802 that includes a user interface 804 equipped with a humanly readable display 806 and a data input 808. The system 800 also includes an authentication translation server 810 in data communication with the document processing device 802 via a network 812. The system 800 further includes an input 814 operable to receive department code data from an associated user via the data input 808 of the user interface 804, and an output 816 configured to communicate received department code data from the document processing device 802 to the authentication translation server 810.

According to one embodiment of the subject application, the authentication translation server 810 is equipped with an associated memory 818 that includes a data map 820 of department code data relative to enterprise application authentication data. The system 800 further includes an enterprise application server 822 that includes at least one enterprise application, and which is operable in connection with receipt of approved enterprise application authentication data. The enterprise application server 822 incorporates an associated input 824 configured to receive, from the authentication translation server 810, enterprise application authentication data corresponding to the received department code. Additionally, the enterprise application server 822 includes an associated authenticator 826 that is operable to test the authenticity of any received authentication data. In accordance with one embodiment of the subject application, the enterprise application is selectively operable in accordance with an output of the authenticator 826.

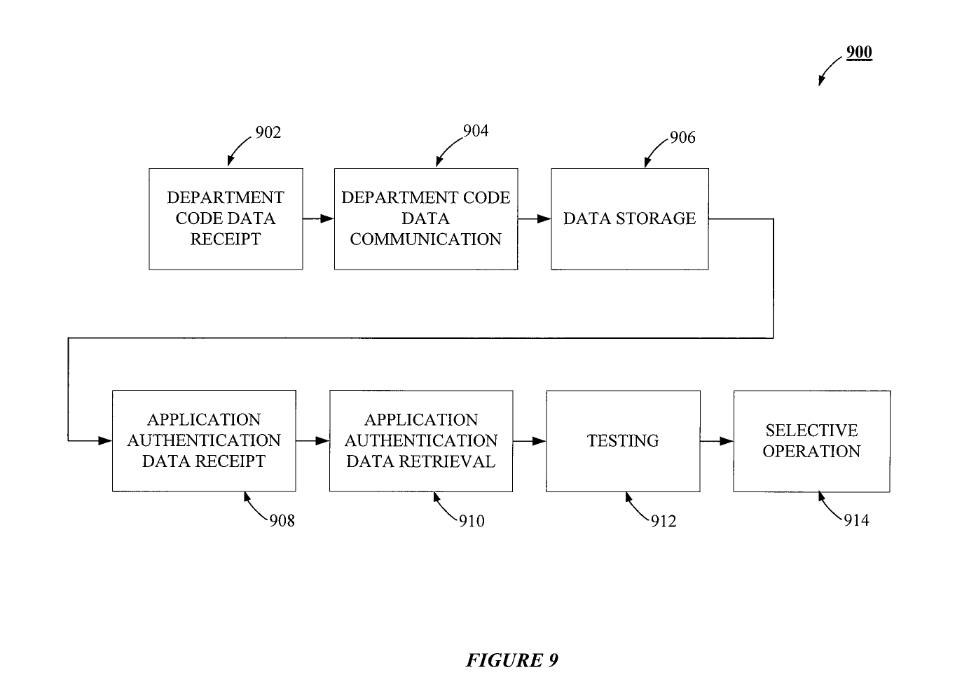

Turning now to FIG. 9, illustrated is a functional diagram of a system 900 for integrating operation of systems employing distinct authentication in accordance with one embodiment of the subject application. As shown in FIG. 9, department code data receipt 902 first occurs from an associated user via a user interface of a document processing device. Department code data communication 904 is then performed of the code data from the document processing device to an authentication translation server. Data storage 906 then occurs of a data map of department code data in a memory associated with the authentication translation server relative to enterprise authentication data.

Application authentication data receipt 908 then occurs at an enterprise application server of data corresponding to the received department code. Application authentication data retrieval 910 is then performed from the memory corresponding to the received department code. Testing 912 is then performed for the authenticity of the retrieved authentication data. Selective operation 914 then occurs of the enterprise application server in accordance with an output of the testing 912.

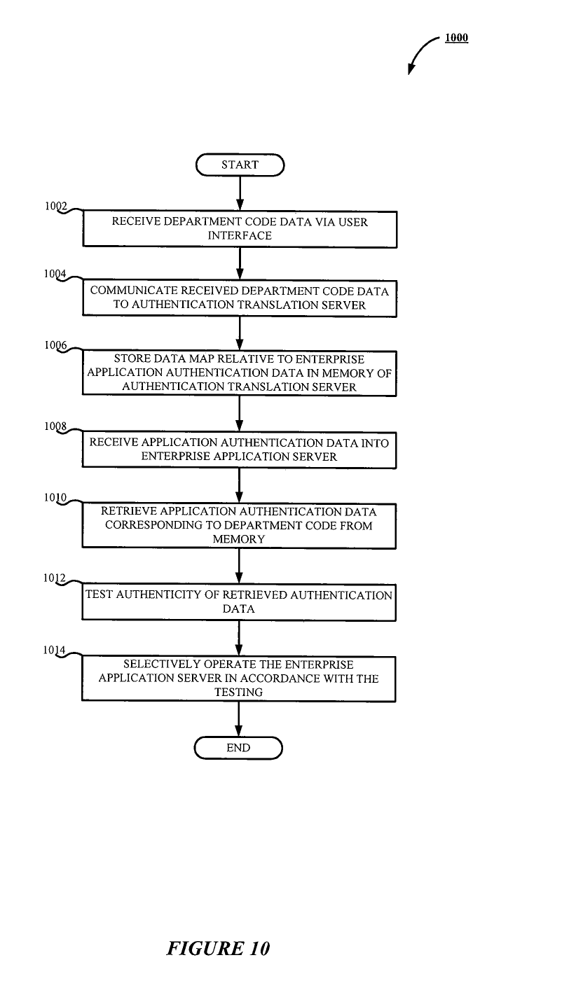

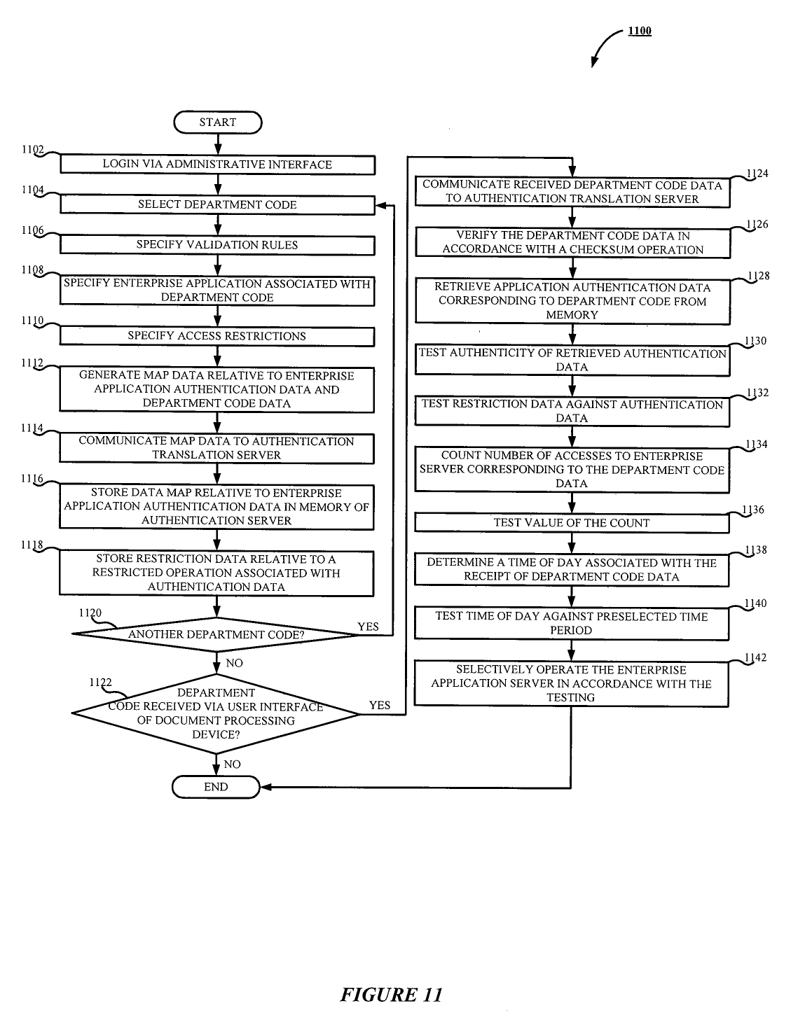

The skilled artisan will appreciate that the subject system 100 and components described above with respect to FIG. 1, FIG. 2, FIG. 3, FIG. 4, FIG. 5, FIG. 6, FIG. 7, FIG. 8, and FIG. 9 will be better understood in conjunction with the methodologies described hereinafter with respect to FIG. 10 and FIG. 11. Turning now to FIG. 10, there is shown a flowchart 1000 illustrating a method for integrating operation of systems employing distinct authentication in accordance with one embodiment of the subject application. Beginning at step 1002, department code data is received from an associated user via a user interface 106 of a document processing device 104. Reference is made herein to the first document processing device 104 with respect to FIG. 10 for example purposes only.

The received department code data is then communicated from the document processing device 104 to an authentication translation server 140 at step 1004. According to one embodiment of the subject application, the department code data includes, for example and without limitation, a personal identification number (PIN) associated with a user, an alphanumeric sequence of characters, a password, username, biometric data, smart card data, or the like. At step 1006, a data map of department code data is then stored in a memory 142 associated with the authentication translation server 140 relative to enterprise authentication data. Application authentication data corresponding to the received department code is then received into an enterprise application server 146 at step 1008. From the memory 142, application authentication data is retrieved at step 1010 corresponding to the received department code. The authenticity of the retrieved authentication data is then tested at step 1012. Thereafter, at step 1014, the enterprise application server 146 is selectively operated based upon the results of the testing performed at step 1012.

Referring now to FIG. 11, there is shown a flowchart 1100 illustrating a method for integrating operation of systems employing distinct authentication in accordance with one embodiment of the subject application. The methodology of FIG. 11 begins at step 1102, whereupon an administrative user accesses an administrative interface via the administrative device 134 so as to generate suitable department code/application authentication data in accordance with one embodiment of the subject application. At step 1104, a department code is selected via the administrative device 134. Validation rules associated with the selected department code are then specified by the user associated with the administrative device 134 at step 1106. The administrative user then specifies one or more enterprise applications, at step 1108, which applications are hosted by the enterprise application server 146 to be associated with the selected department code. Any desired access restrictions, e.g. time of day, number of uses, number of access attempts, cost, etc., are then specified by the administrative user at step 1110.

At step 1112, map data is generated via the administrative device 134 corresponding to a data map of enterprise application authentication data and relative department code data. This map data, along with the specified validation rules and access restrictions, is then communicated to an authentication translation server 140 at step 1114. In accordance with one embodiment of the subject application, the generation of the map data is capable of being performed by the authentication server 140, such that the data is generated subsequent to receipt of the selected department code, validation rules, application selection, and access restriction data from the administrative interface. According to another embodiment of the subject application, the administrative interface of the administrative device 134 enables an administrative user to directly interact with the authentication server 140, e.g. a thin client interface or the like, such that the authentication server 140 interacts in the preceding steps in the manner described above.

The map data received by the authentication translation server 140 is then stored relative to enterprise application authentication data in the memory, e.g. the storage device 110, associated with the server 140 at step 1116. At step 1118, restriction data relative to a restricted operation associated with authentication data is then stored in the data storage 142 associated with the authentication server 140. A determination is then made at step 1120 whether another department code/enterprise authentication relationship is to be made. Upon a positive determination at step 1120, operations return to step 1104, whereupon the administrative user via the administrative device 134 selects another department code for association with enterprise authentication data. When it is determined at step 1120 that no additional department codes have been selected by the administrative user, flow proceeds to step 1122.

At step 1122, a determination is made at one of the document processing devices 104, 114, or 124 whether a department code has been received from an associated user via the respective user interface 106, 116, or 126. When no such department code has been received at the document processing devices 104, 114, or 124, operations with respect to FIG. 11 terminate. Upon receipt of a department code at step 1122, flow proceeds to step 1124, whereupon received department code data is communicated from the document processing device 104, 114, or 124 to the authentication translation server 140 via the computer network 102. At step 1126, the authentication translation server 140 verifies the department code data in accordance with a checksum operation. Following verification at step 1126, the authentication translation server 140 retrieves application authentication data corresponding to the received department code data from the memory 142. It will be appreciated by those skilled in the art that the map data is suitably used by the server 140 so as to retrieve the application authentication data corresponding to the received department code data.

At step 1130, the authenticity of the retrieved application authentication data is tested by the authentication translation server 140. Restriction data is then tested against the authentication data at step 1132. A number of accesses to the enterprise application server 146 is then counted corresponding to the department code data at step 1134. At step 1136, the value of the count is tested against a preselected value. A time of day associated with the receipt of the department code data at the originating document processing device 104, 114, or 124 is then determined at step 1138 and tested against a preselected time period at step 1140. Thereafter, at step 1142, the enterprise application server 146 is selectively operated in accordance with the results of the testing performed at steps 1130, 1132, 1136, and 1140.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for integrating operation of systems employing distinct authentication comprising:
a document processing device including a user interface having a humanly readable display and data input;
an authentication translation server in network data communication with the document processing device;
an input operable to receive department code data from an associated user via the data input;
an output operable to communicate received department code data from the document processing device to the authentication translation server;
a memory associated with the authentication translation server, the memory including a data map of department code data relative to enterprise application authentication data;
an enterprise application server including at least one enterprise application, the enterprise application server being operable in connection with receipt of approved enterprise application authentication data;
an input associated with the enterprise application server operable to receive, from the authentication translation server, enterprise application authentication data corresponding to the received department code;
an authenticator associated with the enterprise application server operable to test authenticity of received authentication data; and
wherein the enterprise application is selectively operable in accordance with an output of the authenticator.

2. The system of claim 1 further comprising a memory associated with the authenticator, the memory storing restriction data corresponding to at least one restricted operation associated with the received authentication data, wherein the authenticator is further operable in accordance with a test of the restriction data against the received authentication data.

3. The system of claim 2 further comprising a counter operable to count a number of accesses to the enterprise application server corresponding to the department code data, and wherein the authenticator is further operable in accordance with a value of the counter.

4. The system of claim 2 further comprising a time-of-day calculator operable to determine a time of day associated with receipt of the department code data, and wherein the authenticator is further operable in accordance with an output of the time-of-day calculator.

5. The system of claim 1 wherein the authentication translation server is further operable to verify the department code data in accordance with a checksum operation.

6. The system of claim 1 wherein the department code is comprised of a personal identification number assigned to the associated user.

7. A method for integrating operation of systems employing distinct authentication comprising:
receiving, via a user interface of a document processing device, department code data from an associated user;
communicating received department code data from the document processing device to the authentication translation server;
storing, in a memory associated with the authentication translation server, a data map of department code data relative to enterprise application authentication data;
receiving into an enterprise application server, application authentication data corresponding to the received department code;
retrieving, from the memory, application authentication data corresponding to the received department code;
testing authenticity of retrieved authentication data; and
selectively operating the enterprise application server in accordance with the testing.

8. The method of claim 7 further comprising storing restriction data corresponding to at least one restricted operation associated with the received authentication data, wherein the testing includes testing the restriction data against the received authentication data.

9. The method of claim 8 further comprising counting a number of accesses to the enterprise application server corresponding to the department code data, and wherein the testing includes testing a value of the count.

10. The method of claim 8 further comprising determining a time of day associated with receipt of the department code data, and wherein the testing includes testing in accordance with a time of day.

11. The method of claim 10 further comprising verifying the department code data in accordance with a checksum operation.

12. The method of claim 7 wherein the department code is comprised of a personal identification number assigned to the associated user.

13. A system for integrating operation of systems employing distinct authentication comprising:
means adapted for receiving, via a user interface of a document processing device, department code data from an associated user;
means adapted for communicating received department code data from the document processing device to the authentication translation server;
means adapted for storing, in a memory associated with the authentication translation server, a data map of department code data relative to enterprise application authentication data;
means adapted for receiving into an enterprise application server, application authentication data corresponding to the received department code;
means adapted for retrieving, from the memory, application authentication data corresponding to the received department code;
means adapted for testing authenticity of retrieved authentication data; and
means adapted for selectively operating the enterprise application server in accordance with the testing.

14. The system of claim 13 further comprising means adapted for storing restriction data corresponding to at least one restricted operation associated with the received authentication data, wherein the means adapted for testing include means adapted for testing the restriction data against the received authentication data.

15. The system of claim 14 further comprising means adapted for counting a number of accesses to the enterprise application server corresponding to the department code data, and wherein the means adapted for testing include means adapted for testing a value of the count.

16. The system of claim 15 further comprising means adapted for determining a time of day associated with receipt of the department code data, and wherein the means adapted for testing include means adapted for testing in accordance with a time of day.

17. The system of claim 16 further comprising means adapted for verifying the department code data in accordance with a checksum operation.

18. The system of claim 13 wherein the department code is comprised of a personal identification number assigned to the associated user.
